(19) United States
(12) Patent Application Publication
(10) Pub. No.: US 2007/0039470 A1
(43) Pub. Date: Feb. 22, 2007

(54) Apparatus and method for collecting contaminants from an air flow for manufacturing semiconductor devices and system using the same

(76) Inventors: Ha-Na Kim, Seoul-city (KR); Dong-Seok Ham, Gyeonggi-do (KR); Yo-Han Ahn, Gyeonggi-do (KR); Chang-Min Cho, Gyeonggi-do (KR); Kwang-Min Choi, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/329,913

(22) Filed: Jan. 10, 2006

(30) Foreign Application Priority Data
Aug. 17, 2005 (KR) 2005-75263

(51) Int. Cl. B01D 47/00

(52) U.S. Cl. 95/210

(57) ABSTRACT

Water discharged at a top region of an eliminator flows, e.g., by gravity into, along, and between the portions of the eliminator while an air flow also travels therein, e.g., horizontally and transverse to the water flow. As the air flow encounters the water, e.g., strikes portions of the eliminator having water flowing downward therealong or encounters water falling between portions of the eliminator, contaminants pass from the air flow to the water flow. The air flow, relieved of certain contaminants, continues onward and the water flow collects at the bottom of the eliminator for filtration and re-circulation through the eliminator.

### CROSS-REFERENCE TO RELATED APPLICATION

The present application claims the priority of Korean Patent Application No. 2005-75263, filed on Aug. 17, 2005 in the Korean Intellectual Property Office. The disclosures of all of the above applications are incorporated herein in their entirety by reference.

### BACKGROUND

1. Field of the Invention

The present invention generally relates to air management and, more particularly, to elimination of air contaminants relative to an air flow applied to a controlled environment such as a clean room environment for manufacturing semiconductor devices.

2. Description of Related Art

In semiconductor wafer processing applications, air introduced into a use space, e.g., a clean room or wafer processing space, must be sufficiently free of contaminants to avoid a variety of issues. For example, contaminants can cause the formation of undesired layers or undesired variations in the profiles or critical dimension of the patterns forming semiconductor devices. In particular, as modern semiconductor patterns become ever-more minute, even airborne molecular contaminants such as NH₃, SOₓ, or Cl⁻ or other general particulate contaminants in an air flow introduced into the clean room can cause undesired formations and profile variations. Accordingly, removal of airborne contaminants has become an important issue in the semiconductor industry. More particularly, contaminants present in a semiconductor manufacturing process can create undesirable circuit bridges, e.g., shorts, affecting performance or quality of the resulting semiconductor product.

Conventionally, a number of different filters have been used to remove different contaminants from the air. Often, a new filter is required when a new contaminant is generated during or introduced into the wafer processing. This can result in an increase in the number of filters. Research has focused on efficient ways to collect different contaminants simultaneously, e.g., using a single device or system, to reduce or manage the contaminant collection costs as contaminant sources become more varied. For example, certain air contaminants can be removed upon contact between the air and water. Upon such contact, contaminants pass from the air flow to the water, e.g., the water collects contaminants from the air flow. The air, having left behind contaminants, is then applied to the wafer processing application, e.g., by further filtration and introduction into the use space.

One such method is described in U.S. Pat. No. 6,874,700, disclosing a contamination control apparatus having a sprayer with at least one nozzle for spraying water and an eliminator through which an air flow passes with the sprayed water to remove contaminants from the air flow. In particular, FIG. 1 illustrates a known method and apparatus wherein the water and the air pass through an eliminator 10 (of a contaminant collector 11) similar to the eliminator shown in U.S. Pat. 6,874,700.

In particular, the eliminator 10 takes the form of a set of pleated plates 12, e.g., having pleat formations 13, with spaces 14 therebetween. A horizontal air flow 16 travels along a direction 18 through the spaces 14 of the eliminator 10 and transverse to the pleat formations 13. The contaminant collector 11 further includes a set of water sprayers 20 located upstream from the eliminator 10. The set of water sprayers 20, disposed horizontally (side-by-side) with respect to the eliminator 10 as show in FIG. 1, point in the direction 18, i.e., along the horizontal air flow 16. The set of water sprayers 20 introduces a water flow 21 in the form of small water droplets into the spaces 14 of the eliminator 10. As the water flow 21 hits plates 12 it diffuses and adheres to, i.e., wets, plates 12. Generally, the water flow 21 should wet the plates 12 and drain out of the eliminator 10. The air flow 16 encounters the water upon the plates 12 and passes contaminants into the water flow 21. The air flow 16 then continues through the eliminator 10, having thereby left behind certain contaminants in the water flow 21.

### SUMMARY

According to features of various embodiments of the present invention, water discharged at the top of an eliminator flows, e.g., by gravity into, along, and between the portions of the eliminator while the air flow also travels therein, e.g., horizontally and transverse to the water flow. As the air flow encounters the water, e.g., strikes wetted portions of the eliminator having water flowing downward therealong or encounters water falling between portions of the eliminator, contaminants pass from the air flow to the water flow. The air flow, relieved of certain contaminants, continues onward and the water flow collects at the bottom of the eliminator.

A contaminant collector according to one embodiment of the invention includes an eliminator with a plurality of plates positioned in face-to-face relation and defining a passageway. An air flow and a fluid pathway reside within the passageway with the fluid pathway being substantially vertical and beginning at a top portion of the eliminator.

According to another embodiment, a contaminant collector includes an eliminator defining a passageway, an air flow pathway along a first direction within the passageway, a fluid pathway along a second direction within the passageway, and a fluid source disposed above the eliminator to release a fluid into the fluid pathway. In one form of this embodiment, the first direction is substantially orthogonal to the second direction.

In a method of collecting contaminants from an air flow according to some embodiments of the present invention an eliminator having a plurality of plates in stacked relation establishes a passageway through the eliminator. In the method of operation, the air flow is directed through the eliminator and the water flow is released vertically downward through the eliminator.

### BRIEF DESCRIPTION OF THE DRAWINGS

The aspects and advantages of the present invention will become more apparent with the detailed description of the exemplary embodiments with reference to the attached drawings.

FIG. 1 (Prior Art) illustrates schematically a prior art eliminator for removing certain contaminants from an air flow passing therethrough.

FIG. 2 illustrates an air management system including, for example, a clean room, and an eliminator for removing certain contaminants from an air flow applied to the managed air space, e.g., to the clean room.

FIG. 3 illustrates schematically an eliminator according to certain embodiments of the present invention.

FIG. 4 illustrates in perspective a first embodiment of an eliminator according to the present invention.

FIG. 5 illustrates in cross-section and during operation the eliminator of FIG. 4.

FIG. 6 illustrates in cross-section an eliminator according to a second embodiment of the present invention.

FIG. 7 illustrates a first alternative form of a liquid supply member for the eliminator according to FIG. 6.

FIG. 8 illustrates a second alternative form of a liquid supply member for the eliminator according to FIG. 6.

FIG. 9 illustrates in perspective an eliminator according to a third embodiment of the present invention.

FIG. 10 illustrates in cross-section and during operation the eliminator according to FIG. 9.

FIG. 11 illustrates a liquid supplying member for the eliminator according to FIG. 10.

FIG. 12 illustrates a nozzle for the liquid supply member of FIG. 11.

FIG. 13 illustrates in cross-section the nozzle of FIG. 12.

FIG. 14 illustrates a first alternative form of nozzle for the liquid supplying member of FIG. 11.

FIG. 15 illustrates a second alternative form of nozzle for the liquid supplying member of FIG. 11.

FIG. 16 illustrates a fourth embodiment of an eliminator according to the present invention and including multiple eliminators in stacked relation.

FIG. 17 schematically illustrates a fifth embodiment of an eliminator according to the present invention and including multiple eliminators in stacked relation.

### DETAILED DESCRIPTION

In the following description, several exemplary embodiments of the invention are described. These exemplary embodiments are not intended to be limiting in any way, but rather to convey the inventive aspects contained in the exemplary embodiments to those skilled in this art. Those skilled in this art will recognize that various modifications may be made to the exemplary embodiments without departing from the scope of the invention as defined in the attached claims.

The contaminant collection capability of an eliminator is limited by the size of the eliminator. The use of conventional, e.g., horizontally directed, sprayers according to known architectures directed along the air flow and into a spray region just upstream of the eliminator including plates is a limitation on the overall horizontal (along the air flow) dimension. In other words, because the sprayers and the spray region occupy the front region of the contaminant collector, the area of the semiconductor manufacturing facility occupied by the contaminant collector, i.e., including the sprayers, the spray region, and the eliminator including the plates, inevitably and undesirably increases.

This, in turn, increases the overall manufacturing costs and frustrates the general need to reduce the area of the semiconductor manufacturing facility. This is particularly true as the contaminants are more efficiently collected by the water between and adhered to the plates (80% collection efficiency) rather than by the water in the spray region (20% collection efficiency). Thus, in the prior art, the longer the length of the eliminator plates, the higher the contaminant collection efficiency of the eliminator. However, because of the above-noted limitation due to use of horizontally-directed sprayers and a spray region just upstream of the eliminator plates, increasing the collection efficiency has been difficult.

Further, as discussed more fully hereafter, experimentation has shown that the collection capability differs in different regions of the conventional eliminator. For example, the collection capability is lower in the top and rear regions of the eliminator as compared to the bottom and middle regions. The top and front region is wetted exclusively by the water flow arriving in a horizontal direction. The entire middle and bottom regions are wetted by water flow from both a horizontal direction and from water flowing downward from the top region. Accordingly, the top region is less wetted than the bottom and middle regions. As a result, the air flow passing through the top region can carry more contaminants than allowed, e.g., when it reaches the clean room. These problems may become more severe as the size of the eliminator increases.

Also, the use of relatively high-velocity sprayers used to produce a horizontal water flow presents a contaminant source. As the sprayers wear away, the material forming the sprayers wears away into the water flow and pollutes the system. Also sprayers require a certain amount of maintenance and, as a result, represent a factor in increased overall operating time and increased cost of operation. These problems become more severe as the conventional contaminant collector requires a large number of spray nozzles for the sprayers.

Finally, the velocity of the air flow can be difficult to control. When the air flow is relatively slow, the water flow may not reach the rearward region of the eliminator. When the air flow is relatively fast, contact time between the air flow and the water flow along the eliminator plates shortens and thereby reduces the collection capability of the eliminator and reduces throughput.

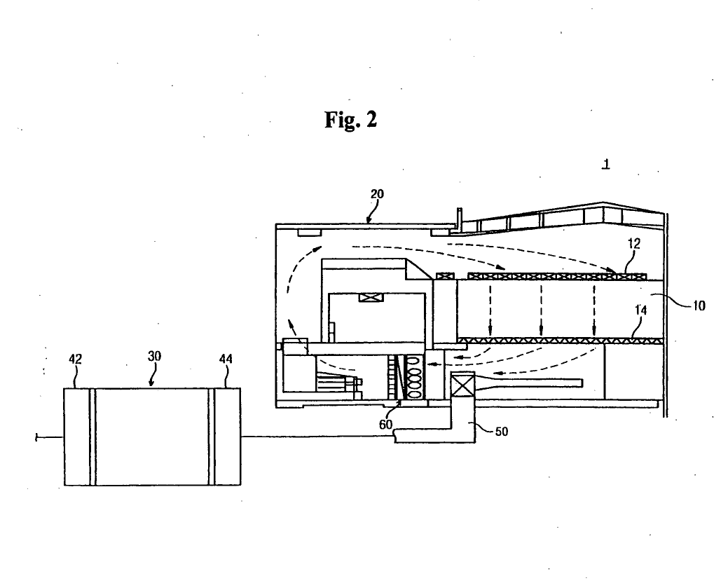

FIG. 2 schematically illustrates an example wafer processing facility as an air management embodiment of the present invention and will be discussed more fully hereafter.

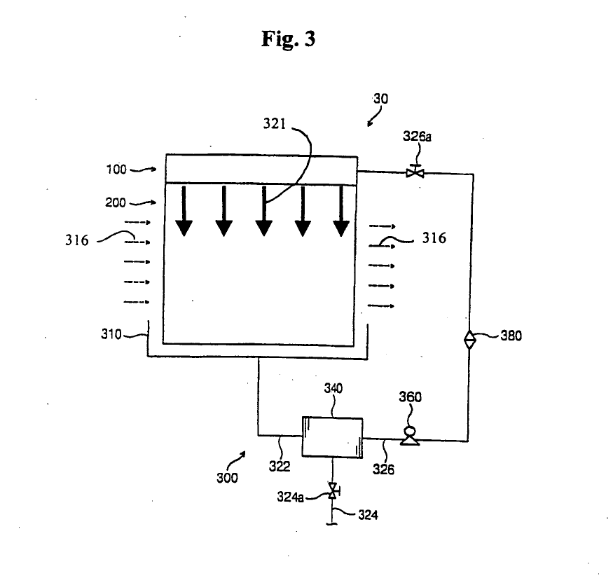

The wafer processing facility of FIG. 2 includes a contaminant collector 30 according to a selected embodiment thereof, e.g., as shown in FIG. 3 or other forms of contaminant collector according to some embodiments of the present invention.

FIG. 3 illustrates, in accordance with certain aspects of the present invention overcoming the above-described problems identified by the applicant, a contaminant collector 30. In this embodiment of the present invention, the contaminant collector 30 includes a liquid supplying member or a fluid source 100 disposed over an eliminator 200. A liquid circulation unit 300 resides under the eliminator 200. The liquid supplying member 100 provides a liquid or fluid such as de-ionized (D.I.) water (hereinafter “water”) to the eliminator 200. It will be understood, however, that the liquid may be any liquid suitable to collect contaminants from the air flow 316. While not detailed in FIG. 3, the eliminator 200 may take a variety of specific forms, including the form of a set of pleated hydrophilic plates with spaces therebetween.

An air flow 316 passes horizontally through the eliminator 200, e.g., along the direction indicated in FIG. 3. The liquid supplying member 100, disposed above the eliminator 200, releases to gravity a water flow 321 into the eliminator 200 while the air flow 316 passes horizontally through the eliminator 200. Thus, the spaced plates of the eliminator define a passageway accommodating in the space between the plates and along the surfaces of the plates for water flow 321. In this manner, the water flow 321 moves generally vertically from the top to the bottom of the eliminator 200 in the spaces between the plates and along the surfaces of the plates.

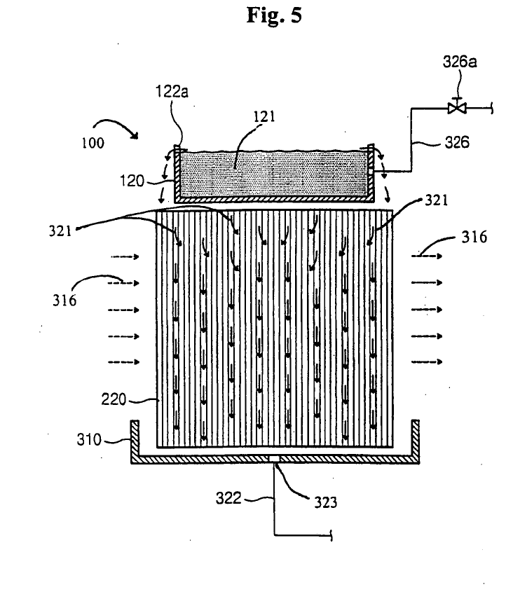

The circulation unit 300 may include a water support 310, a recovery line 322, a fresh water supply 324, a supply line 326 having a valve 326a for controlling the flow of water therethrough (not shown), a storage tank 340, a pump 360, and a filter 380. In particular, the circulation unit 300 may provide the water support 310 just below the eliminator 200 to collect the exhausted water flow 321 into the recovery line 322, e.g., through an exit 323 (FIG. 5) formed below the water support 310. The water taken from the water flow 321 thereby passes to the storage tank 340. The pump 360 collects water from the storage tank 340 along the supply line 326 and, by way of the filter 380 and a control valve 326a, provides water to the liquid supplying member 100. Thus, the water in the storage tank 340 is provided to the liquid supplying member 100 via the supply line 326. The contaminants present in the water can be removed through the serially-disposed filter 380. The fresh water supply 324 couples by way of a control valve 324a to the storage tank 340 such that the fresh water can be supplied to the storage tank 340 in place of spent water, e.g., water repeatedly circulated and, therefore, with diminished contaminant-collecting efficiency.

Generally, water thereby circulates through the contaminant collector 30 and, as it passes downward through the eliminator 200, certain contaminants are taken from the air flow 316 and filtered at the filter 380. The air flow 316 continues onward for use in a controlled environment, e.g., a clean room manufacturing environment. The control valve 326a may be used to manage the amount of water passing through the eliminator 200 while the control valve 324a may be used to introduce additional, e.g. fresh, water into the contaminant collector 30 as necessary.

With the liquid supplying member 100 positioned above the eliminator 200, water flows downward under influence of gravity into the eliminator 200, e.g., generally vertically from the top region to the bottom region. The water flow 321 thereby wets the plates of the eliminator 200, and to some degree falls through the spaces between the plates of the eliminator 200. The air flow 316 encounters the water flow 321 as it flows along surface portions, e.g., pleat formations, of the eliminator 200 and as it falls through the spaces, e.g., between the plates, of the eliminator 200. Upon such encounter, contaminants in the air flow 316 pass into the water flow 321. In particular, the eliminator 200 removes the contaminants from the air by allowing the water to contact the contaminants suspended in the air. The water thereby absorbs air-borne molecular contaminants (e.g., NH₃, SOₓ, NOₓ, Cl⁻, HCOO⁻) and/or general particulate contaminants. The water flow 321 then collects at the water support 310. Water re-circulates through the contaminant collector 30, with contaminants being additionally removed from circulation at the filter 380.

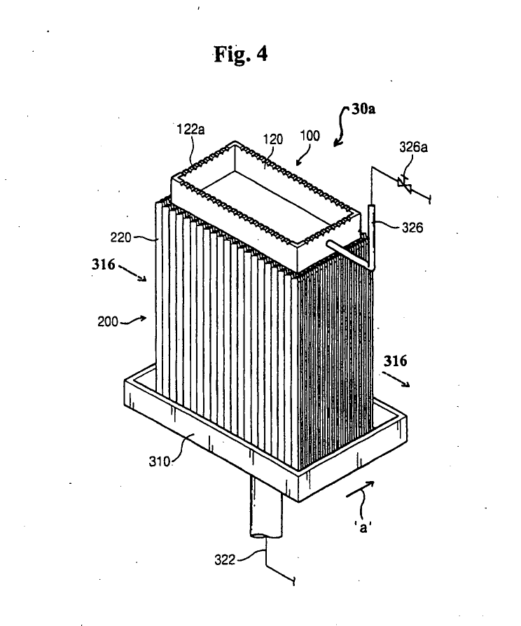

FIG. 4 illustrates in more detail a first embodiment of the present invention, a contaminant collector 30a. In FIG. 4, the eliminator 200 includes a set of pleated plates 220 arranged in such relation to the air flow 316 to allow passage of air flow 316 through the spaces between plates 220, e.g., stacked in spaced relation along a direction ‘a’ thereby aligning the spaces therebetween with the air flow 316 passing through the eliminator 200. Thus, the direction ‘a’ may be perpendicular to the direction of the air flow 316. As may be appreciated, the pleated plates 220 offer to the air flow 316 undulating surfaces (along the direction of the air flow 316) as air flow 316 passes through the eliminator 200. In other words, gaps between the plates 220 allow a flow path for the air flow 316 and the pleated shape of the plates 220 allow the air flow 316 to collide with the plates 220. As will be appreciated, the plates 220 may include a hydrophilic surface treatment thereby encouraging the water flow 321 to wet and to travel along the surface thereof. This arrangement provides opportunity for the air flow 316 to strike the water flow 321 as it travels along the surfaces of the pleated plates 220 and as it falls through the spaces between the pleated plates 220.

As discussed above, at this time, contaminants in the air flow 316 pass into the water flow 321 and the water flow 321 then collects at the water support 310. The water support 310 takes generally the form of a basin having a drain directing collected water into the recovery line 322. However, one skilled in the art will appreciate that the arrangement of the set of plates 220 with respect to the direction of the air flow 316 can be adjusted depending on the particular application, e.g., not necessarily limited to one described above. Also, the shape of the plates 220 can be varied depending on the particular application as long as they are suitable for collecting the contaminants from the air. For example, the plates 220 can be porous.

The liquid supplying member 100 as positioned above pleated plates 220 receives water from the supply line 326 under control of the valve 326a. The liquid supplying member 100 generally takes the form of a bath 120 filled with a body of water therein. A plurality of spillways or grooves 122a positioned about the upper periphery of the bath 120 allow water to overflow in a controlled and well-distributed fashion, e.g., as by operation of valve 326a. The water flow 321 thereby originates in at the groves 122a for discharge under influence of gravity downward and through the eliminator 200, e.g., flowing along the surfaces of the pleated plates 220 and falling in the spaces or gaps therebetween.

FIG. 5 illustrates in cross-section the contaminant collector 30a of FIG. 4 including a body of water 121 in the bath 120. The control valve 326a has filled the bath 120 such that the body of water 121 overflows the bath 120 at the grooves 122a. As the water floods from the top peripheral region of the eliminator 200 it moves into the top center region and expands as it flows downwardly along the surfaces of the pleated plate 220 and falls downwardly through the spaces between the pleated plates 220. The water flow 321 thereby wets the exposed surfaces of the pleated plates 220. As a result, the air flow 316 passing through the eliminator 200 encounters the water flow 321 and transfers certain contaminants thereto. The water flow 321 eventually reaches the water support 310 for collection, filtering and re-circulation back to the bath 120.

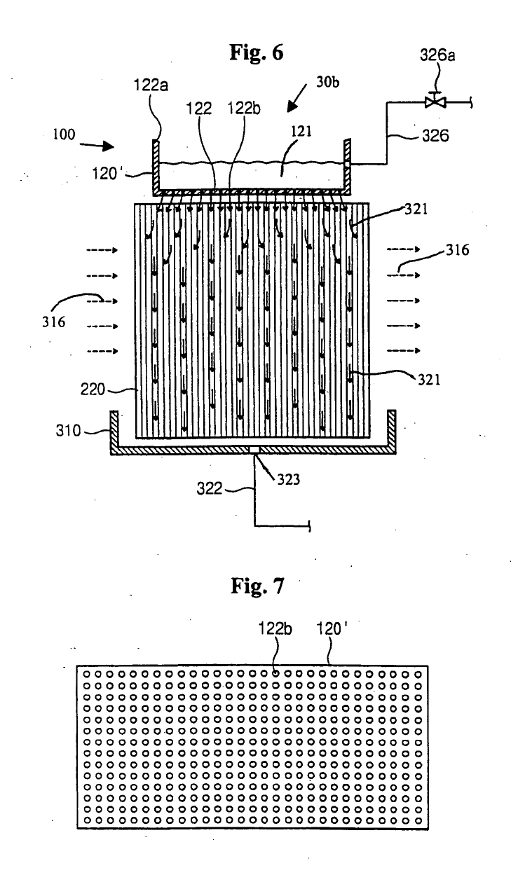

FIG. 6 illustrates a second embodiment of the present invention, a contaminant collector 30b. The contaminant collector 30b is generally similar to the contaminant collector 30a of FIGS. 4 and 5, having the eliminator 200 comprising pleated plates 220 allowing the air flow 316 therethrough, a water support 310 to gather the water flow 321 as it falls or discharges from the lower region of the eliminator 200, and a recovery line 322 for passing the water into re-circulation. The control valve 326a controllably fills a bath 120′ via the supply line 326. In the contaminant collector 30b, however, the liquid supplying member 100 discharges water from the bath 120′ at openings 122 located, for example, across its lower surface. In this manner, the water flow 321 originates as a distributed flow across the top region of the pleated plates 220. The openings 122 of bath 120′ may be arranged regularly at a substantially equal distance.

FIG. 7 illustrates a first arrangement for the bath 120′ having a plurality of, for example, circular apertures 122b as openings 122.

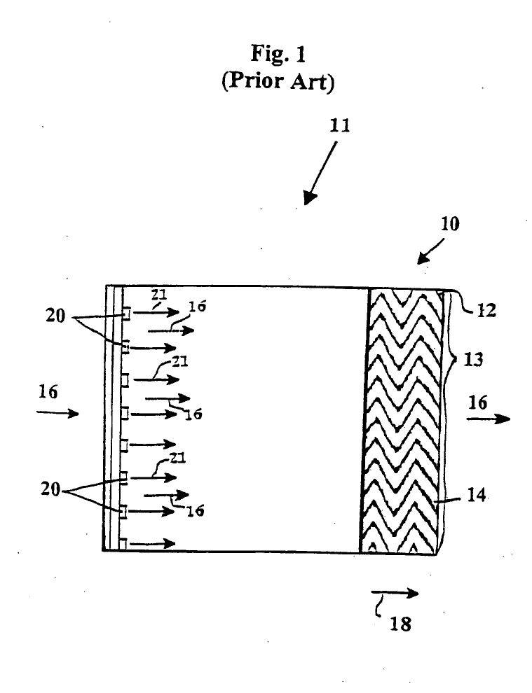

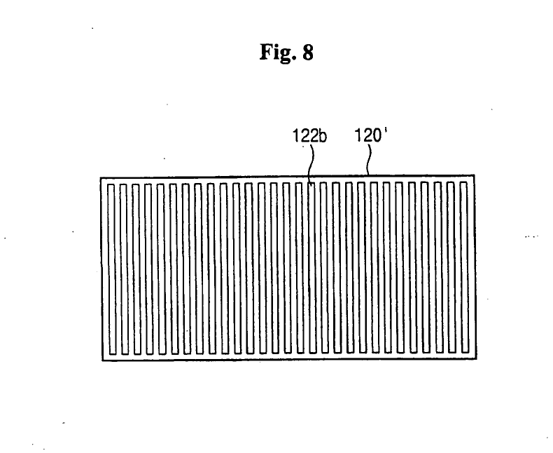

FIG. 8 illustrates a second arrangement for bath 120′ having a plurality of slits 122b as openings 122. The plurality of slits 122b may be arranged in parallel or perpendicular relation to the stack direction ‘a’ of the pleated plates 220. Furthermore, it will be understood that a variety of opening 122 shapes and orientations may be used to produce a discharge of water from bath 120′ and downward into the eliminator 200. For example, the plurality of slits 122b may form an obtuse or acute angle with respect to the stack direction ‘a’. With such structures, the water can be uniformly distributed to the top region of the eliminator 200. Also, as compared to the prior art method using spray nozzles shown in FIG. 1, the structure allows a simplified architecture and requires substantially less maintenance.

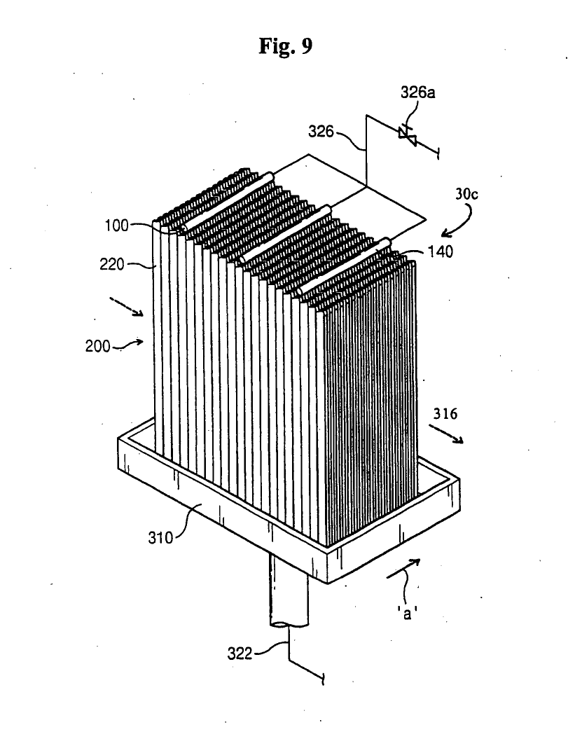

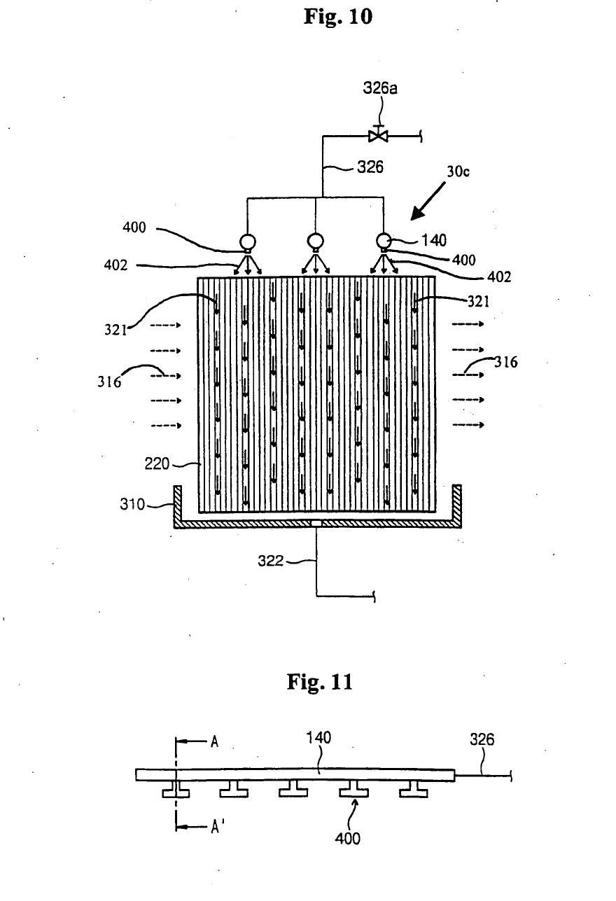

FIGS. 9 and 10 illustrate a third embodiment of the present invention, a contaminant collector 30c. In FIG. 9, as shown in perspective, the contaminant collector 30c is generally similar to the contaminant collectors 30a and 30b, having the eliminator 200 comprising pleated plates 220 allowing the air flow 316 therethrough, a water support 310 to gather the water flow 321 as it falls from the lower region of the eliminator 200, and a recovery line 322 for passing the water back into re-circulation. In the contaminant collector 30c, however, a control valve 326a controls application of pressurized water, by way of the supply line 326, to one or more supply pipes 140 located above the eliminator 200. The supply pipes 140 are formed in the shape of a rod having a plurality of holes formed at a lower portion thereof and along the lengthwise direction of the rod. If plural supply pipes 140 are disposed over the eliminator 200, the supply pipes 140 may be disposed at regular intervals. The supply pipes 140 are illustrated as substantially perpendicular to the pleated plates 220, i.e., parallel to the direction ‘a’ shown in FIG. 4, but may be orientated in perpendicular or other relation to the pleated plates 220. For example, the supply pipes 140 may form an obtuse or acute angle with respect to the pleated plates 220 depending on applications.

In FIG. 10, as shown in cross-section, the contaminant collector 30c provides at supply pipes 140 a set of nozzles 400 producing water sprays 402. The water sprays 402 may be of such pressure and character to form an atomized water flow directed downward into the eliminator 200. Furthermore, a particular embodiment of the contaminant collector 30c may include one or more supply pipes 140 and one of more nozzles 400. By originating water flow 321 as the sprays 402 directed at the top of the eliminator 200, water flow 321 is well distributed across the top region of the eliminator 200 for subsequent movement under influence of gravity downward flowing along the surfaces of the pleated plates 220 and falling through the spaces therebetween. Furthermore, the magnitude of spray velocity and volume need not be as great as that of horizontally directed spray arrangements such as that found in the prior art.

Referring to FIG. 11, a cross-sectional view of the supply pipe 140 coupled with the nozzles 400, the supply pipe 140 is in fluid communication with the supply line 326 to receive water, e.g., re-circulated and filtered water, as discussed above.

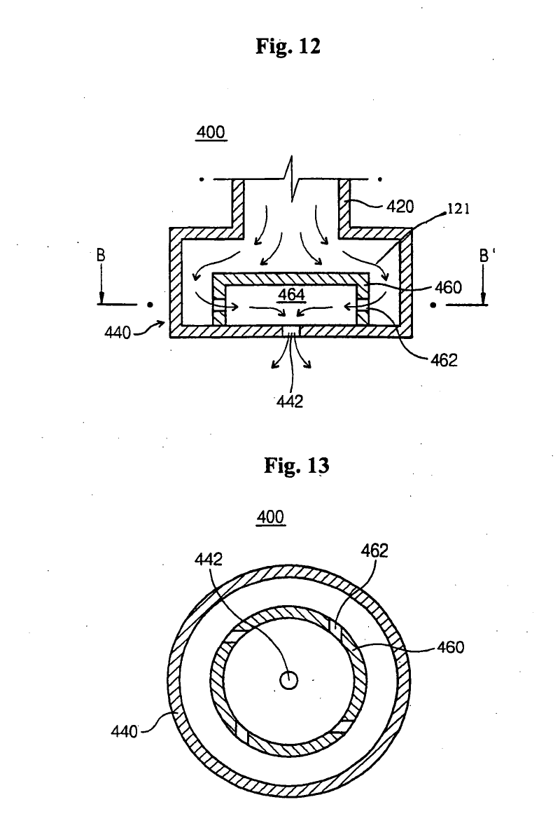

FIGS. 12 and 13 illustrate a first form of the nozzles 400. FIG. 12 illustrates the nozzle 400 in cross-section as taken along line A-A′ in FIG. 11. FIG. 13 illustrates the nozzle 400 in cross-section as taken along line B-B′ in FIG. 12. It will be understood, however, that contaminant collector 30c may be implemented according to a variety of nozzle forms. In FIG. 12, a linking part or inlet 420 of the nozzle 400 couples to the supply pipe 140 through the corresponding hole formed at the lower portion thereof as described above and receives pressurized water 121 therefrom. The nozzle 400 further includes an enlargement section 440, having a diameter greater than that of the inlet 420 and passing the water into a turn inducing section 460 at angularly disposed inlets 462 thereof. The turn inducing section 460 thereby imparts a rotational aspect to movement of the water as it enters a space 464 of the turn-inducing section 460. The water thereby spins and exits an orifice 442 at a particular angle as a spray 402. Both the enlargement section 440 and the turn inducing section 460 may be cylindrical with the turn inducing section 460 being smaller in diameter and nested within the enlargement section 440. The turn inducing section 460 has an upper wall having the shape of a disk and a cylindrical sidewall extending from the upper wall and being coupled to the lower wall of the enlargement section 440. The upper wall and the sidewall of the turn inducing section 460 and the lower wall of the enlargement section 440 collectively form the space 464. Thus, water reaching the space 464 exits nozzle 400 at an outlet 442 as a spray 402 forming water flow 321.

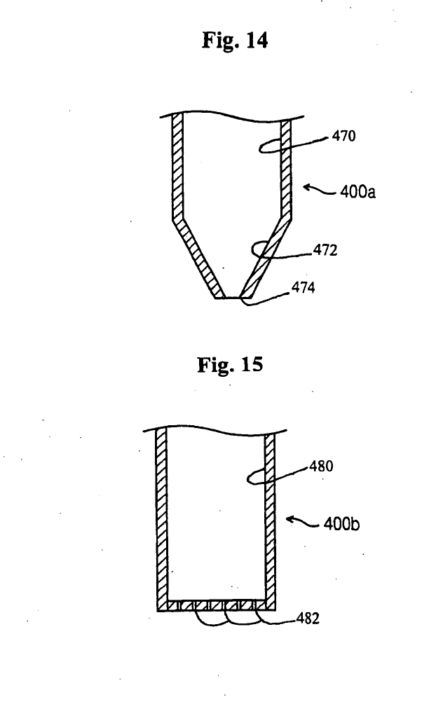

FIG. 14 illustrates a form of nozzle 400a attachable to the supply pipes 140 and including a generally cylindrical inlet section 470 followed by a conic section 472 and an outlet 474 at the narrow end of the conic section 472. The diameter of the outlet 474 may be about 1000 μm or greater as long as the nozzle 400a can sufficiently wet, for example, the plates 220.

FIG. 15 illustrates a form of nozzle 400b also attachable to supply pipes 140 and presenting a cylindrical inlet section 480 and a plurality of outlets 482.

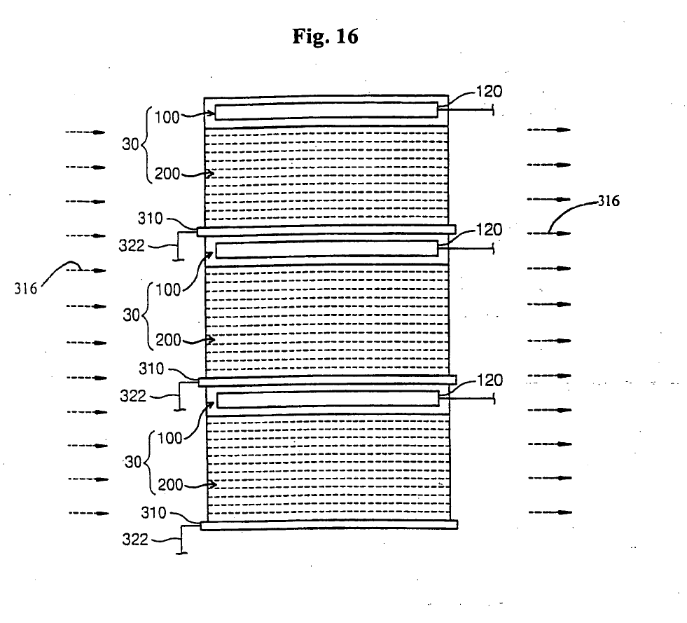

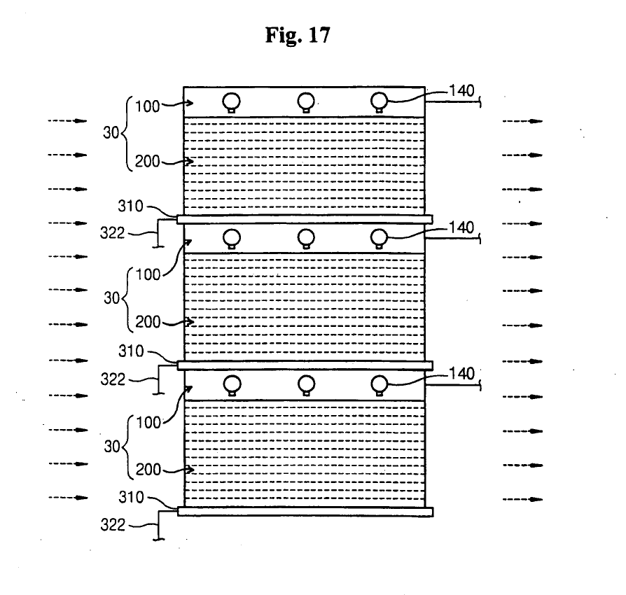

FIGS. 16 and 17 illustrate combining multiple contamination collectors 30 in stacked relation. For example, in each arrangement a set of contamination collectors 30 include a liquid supplying member 100 and a water support 310 with an eliminator 200 interposed therebetween. Thus, the liquid supplying member 100 is disposed above the eliminator 200 in each collector 30 to provide water to the top or upper region of the eliminator 200. In other words, the water flow 321 (not shown) for each the contaminant collectors 30 may be isolated relative to the others. Thus, water flowing through a given eliminator 200 is collected at the lower region thereof. Air flow 316 passes through the set of the contaminant collectors 30. In FIG. 16, contaminant collectors 30 each make use of a bath 120 as a liquid supplying member 100, e.g., one or more of baths 120 or 120′. In FIG. 17, each of contaminant collectors 30 each make use of supply pipes 140 and sprayers 400 as a liquid supply member 100. As may be appreciated, a variety of combinations of liquid supplying members 100 may be used in a given combined or stacked form of contaminant collector arrangement.

Returning to FIG. 2, showing a processing facility 1 according to an air management embodiment of the present invention, the collector 30 can be incorporated, for example, into an external air-conditioning system of the processing facility 1. The processing facility 1 includes a use space or clean room 10 with a fresh air duct 50 disposed between the collector 30 and the clean room 10. More particularly, the processing facility 1 includes the clean room 10 within a frame 20. A body of air re-circulates relative to clean room 10, e.g., taken from floor 14 of clean room 10 and returned at ceiling 12 of clean room 10. The fresh air duct 50 couples to the body of re-circulating air, e.g., below a floor 14 of clean room 10, to provide clean air from the external air conditioning system. With the contaminant collector 30 operating along the fresh air duct 50, air so introduced into the body of re-circulating air presents reduced risk of undesirable external contamination.

Within the clean room 10, various semiconductor-manufacturing apparatuses (not shown) can be installed. A filter (not illustrated) installed at ceiling 12 or upper wall of the clean room 10 further removes contaminants from air as the air enters the clean room 10. Also, the floor 14 of the clean room 10 is formed of a grating plate, e.g., includes a plurality of holes formed therethrough. Below the floor 14 of the clean room 10, an air transport or circulation unit 60 drives air re-circulation, i.e., moves the body of air from the floor 14 back to the ceiling 12. According to one aspect of the present invention, in the circulating unit 60, various additional filters can be installed to remove contaminants from the air. In other words, the circulation unit 60 moves the air from the area below the cleaning room 10 to the area above the clean room 10 as indicated by arrows shown in FIG. 2. Subsequently, the air above the clean room 10 is forced into the clean room 10 through the filter of ceiling 12. The air generally flows from the top to the bottom of the clean room 10. Then, the air exits through the grating plate of the floor 14 and re-circulates under influence of the circulation unit 60 as described above.

Alternatively, the collector 30 may be installed serially along the fresh air duct 50, e.g., instead of or in addition to being placed more remotely in the external air-conditioning system. In addition, fans may be incorporated into a given contaminant collector 30. For example, a forward fan 42 drives air into contaminant collector 30. Alternatively, or in addition to fan 42, a rearward fan 44 draws air through contamination collector 30. As may be appreciated, fans 42 and 44 can be used to better control air flow through contaminant collector 30.

As described above, the contaminant collector 30 can be installed in the clean air duct 50. Alternatively or in addition, the contaminant collector 30 can be installed in the circulation unit 60, in the ceiling of the clean room 10, or in the processing equipment disposed within the clean room 10. Thus, the contaminant collector 30 according to various embodiments of the present invention can be employed as a contaminant collector according to various schemes, some of which are disclosed in U.S. Pat. No. 6,874,700, the contents of which are incorporated herein by reference.

Eliminators according the various embodiments described and illustrated herein offer certain comparative advantages over the conventional eliminator as illustrated in FIG. 1.

It has been shown that contaminant collection capability is dependent on the width, e.g., along the direction of air flow, of the eliminator. In FIG. 1, the horizontal dimension of the contaminant collector, e.g., along the air flow 16 must accommodate not only the pleated plates but also the nozzles 20 and the associated area, i.e., the spray region, between the nozzles and the plates. However, the corresponding same dimension, e.g., along the direction of air flow, according to the above-illustrated embodiments need only accommodate the pleated plates. As a result, an eliminator according to embodiments illustrated herein can be narrower if desired or, more desirably, present a greater opportunity for contaminant collection, e.g., allow a wider set of pleated plates in the same overall horizontal space. Because contaminant collection capability is related to eliminator width, this offers opportunity for greater contaminant collection capability.

Furthermore, plate-wetting efficiency is substantially improved according to embodiments shown herein. In a conventional eliminator, the water is blown horizontally by force of spray and air flow into the spaces between the plates. This results in inconsistent wetting of the plate surfaces. More particularly, as the water is forced laterally into the conventional eliminator it eventually falls therein and tends to provide relatively less wetting in the upper more downstream or distant plate surfaces and tends to provide relatively greater or excess wetting in the lower more upstream or closer plate surfaces. Given this differential in wetting, a collection capability differential exists and relatively less contaminants are collected in the upper portions of the conventional eliminator. An eliminator according to some embodiments of the present invention, e.g., having water introduced from above, enjoys relatively uniform wetting of the plate surfaces and, therefore, more uniform contaminant collection throughout the eliminator.

Also, the degree to which water uniformly penetrates the conventional eliminator is dependent on air flow velocity. Unfortunately, in certain arrangements precise control over air flow velocity is difficult to maintain. In other words, air flow velocity in certain cases must be accepted as variable. As a result, the degree to which water is carried relatively uniformly into the conventional eliminator can vary as a function of air flow velocity. At relatively lower air flow velocities, contaminant collection efficiency is reduced at the more distant or downstream portions of the eliminator. An eliminator according to embodiments of the present invention, however, with the water introduced from above and moving more substantially under the uniform force of gravity enjoys more uniform wetting of the plates even when the air flow velocity varies. As a result the plate-wetting or attaching function is more uniform throughout the eliminator and contaminant collection improves.

Table 1 below compares the amounts of contaminants removed from the air using a conventional contaminant collector (System 1) and a contaminant collector 30 (System 2) in accordance with an embodiment of the present invention. The width of the conventional contaminant eliminator of system 1 is about 300 mm and the width of the eliminator of system 2 is about 400 mm (along the direction of the air flow). The data were collected using a high performance ion chromatography (HPIC) method as known to one skilled in the art.

TABLE 1

| | NH₃ | SOₓ | NOₓ | Cl | HCOO— |
|---|---|---|---|---|---|
| System 1 | 80% | 70% | 30% | 40% | 35% |
| System 2 | 92% | 89% | 68% | 80% | 85% |

In fact, the width of the conventional collector including that of the eliminator is three or four times the width of the eliminator itself in system 1 because the horizontal dimension of the collector must accommodate not only the plates but also the nozzles and associated downstream area intermediate the nozzles and the plates as explained above. However, the width of the overall contaminant collector in accordance with an aspect of the present invention is substantially the same as the width of the eliminator plates. That is, under some embodiments of the invention, the eliminator is substantially the entire width while the prior art includes additional equipment (sprayers) within the overall width. Consequently, a contaminant collector according to embodiments of the present invention, e.g., system 2, takes up much less space as compared to the conventional contaminant collector even though the contaminant removal efficiency is substantially higher according to some embodiments of the present invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Various operations have been described as multiple discrete steps performed in a manner that is most helpful in understanding the invention. However, the order in which the steps are described does not imply that the operations are order-dependent or that the order that steps are performed must be the order in which the steps are presented.

Having described and illustrated the principles of the invention in several preferred embodiments, it should be apparent that the embodiments may be modified in arrangement and detail without departing from such principles. We claim all modifications and variation coming within the spirit and scope of the following claims.

1. A contaminant collector comprising:
an eliminator defining a passageway therein;
an air flow pathway along a first direction within the passageway;
a fluid pathway along a second direction within the passageway; and
a fluid source disposed above the eliminator to release a fluid into the fluid pathway.

2. The collector of claim 1, wherein the first direction is substantially orthogonal to the second direction.

3. The collector of claim 1, wherein the eliminator comprises a plurality of plates and the passageway includes a space between the plates.

4. The collector of claim 1, wherein the eliminator comprises a plurality of plates and the passageway includes surfaces of the plates.

5. The collector of claim 1, wherein the eliminator comprises a plurality of plates and the passageway includes surfaces of the plates and spaces between the plates.

6. A contaminant collector comprising:
an eliminator including a plurality of plates in stacked relation and defining a passageway;
an air flow pathway within the passageway; and
a fluid pathway within the passageway,
wherein the fluid pathway is vertical and begins at a top portion of the eliminator.

7. The collector of claim 6, further including a fluid source disposed above the eliminator comprising:
a fluid supply to provide a fluid; and
a reservoir to receive the fluid from the fluid supply, the reservoir having an outlet to release the fluid downward into the fluid pathway.

8. The collector of claim 7, wherein the outlet comprises spillways to release a fluid overflow therefrom.

9. The collector of claim 7, wherein the outlet comprises apertures to discharge a flow of the fluid.

10. The collector of claim 9, wherein the apertures are formed in the shape of a circle.

11. The collector of claim 9, wherein the apertures are formed in the shape of a slit.

12. The collector of claim 11, wherein the apertures formed in the shape of a slit are arranged in at least one of parallel and perpendicular relation to the stacked direction of the plates.

13. The collector of claim 11, wherein each slit forms an obtuse or acute angle with respect to the stacked direction of the plates.

14. The collector of claim 7, wherein the fluid comprises water.

15. The collector of claim 6, further including a fluid source disposed above the eliminator comprising:
a fluid supply to provide a fluid under pressure; and
at least one discharge tube coupled to the fluid supply and including at least one nozzle to direct the fluid downward into the fluid pathway.

16. A contaminant collector comprising:
an eliminator including a plurality of plates positionable in face-to-face relation and defining a passageway;
an air flow pathway along a first direction within the passageway;
a fluid pathway vertically downward along a second direction within the passageway and beginning at a top portion of the eliminator; and
a fluid source to introduce fluid into the fluid pathway at the top portion of the eliminator, the fluid pathway allowing a downward flow of fluid under influence of gravity.

17. The collector of claim 16, wherein the passageway includes spaces between the plates.

18. The collector of claim 16, wherein the passageway includes surfaces of the plates.

19. The collector of claim 16, wherein the plurality of plates include non-planar surfaces.

20. The collector of claim 19, wherein the non-planar surfaces comprise pleat formations.

21. The collector of claim 20, wherein the pleat formations lie substantially parallel to the second direction and substantially orthogonal to the first direction.

22. In a method of collecting contaminants from an air flow using an eliminator having a plurality of plates in stacked and spaced relation to establish a passageway through the eliminator, the method comprising:
directing the air flow through the eliminator; and
releasing a water flow vertically downward through the eliminator.

23. The method of claim 22, wherein releasing a water flow includes releasing a water flow within the spaces between the plates.

24. The method of claim 22, wherein releasing a water flow causes a water flow along the surfaces of the plates.

25. The method of claim 22, wherein the air flow is substantially horizontal.

26. The method of claim 22, wherein the water flow is from a top portion of the eliminator to a bottom portion of the eliminator.

27. The method of claim 22, wherein releasing a water flow comprises releasing water at a top portion of the eliminator.

28. The method of claim 22, wherein releasing a water flow comprises providing a reservoir spillway overflow.

29. The method of claim 22, wherein releasing a water flow comprises providing a reservoir aperture discharge.

30. The method of claim 22, wherein releasing a water flow comprises spraying water downward into the eliminator.

31. The method of claim 22, further comprising maintaining at least two eliminators in vertically stacked relation, each being operated to direct an air flow therethrough and to release a water flow vertically downward thereinto.

32. An air management system comprising:
a use space to receive managed air;
an air transport to move an air flow along an air flow path toward and into the use space; and
a contaminant collector comprising a plurality of plates maintained in face-to-face relation to establish a passageway therethrough, the contaminant collector being positionable along the air flow path to allow passage of the air flow through the passageway, and a water source positionable above the eliminator to allow a water flow vertically downward within the passageway.

33. The method of claim 32, wherein the water flow is substantially orthogonal to the air flow.

34. The method of claim 32, wherein the water source is positionable at a top portion of the eliminator to allow a gravity-fed downward water flow through the eliminator.

35. An eliminator comprising:
a plurality of pleated plates maintained substantially upright and in spaced substantially parallel relation to establish a plurality of pathways to allow an air flow horizontally therethrough;
a liquid supplying member postionable above the plates to release a water flow downward into the pathways; and
a liquid support positionable below the plates to collect the water flow from the pathways.

36. The eliminator of claim 35, wherein the liquid supplying member releases the water flow downward to the influence of gravity.

37. The eliminator of claim 35, wherein the liquid supplying member comprises a bath and the water flow originates at least in part as a spillway overflow relative to the bath.

38. The eliminator of claim 35, wherein the liquid supplying member comprises a bath having at least one aperture and the water flow originates at least in part as an aperture discharge.

39. The eliminator of claim 35, wherein the liquid supplying member sprays the water flow downward into the pathways.

40. The eliminator of claim 35, wherein the liquid supplying member sprays an at least partially atomized water flow downward and into the pathways.

41. The eliminator of claim 35, wherein the claimed eliminator comprises a first eliminator, further comprising a second eliminator corresponding in structure to the first eliminator and in stacked relation to the first eliminator.

42. A contaminant collector comprising:
at least two eliminators in vertically stacked relation, each eliminator including a plurality of plates positioned in face-to-face relation and defining a passageway, an air flow pathway within the passageway, a fluid source at the top of the eliminator, a fluid pathway within the passageway, the fluid pathway being vertical and coupled to the fluid source, and a fluid support collecting fluid from fluid pathway, the fluid source of a lower eliminator being positioned below the fluid support of an upper eliminator.
